(19) United States
(12) Patent Application Publication
(10) Pub. No.: US 2005/0256261 A1
(43) Pub. Date: Nov. 17, 2005

(54) Aqueous polyurethane dispersions and their use as adhesives

(76) Inventors: Wolfgang Arndt, Dormagen (DE); Wolfgang Henning, Kurten (DE); Jurgen Meixner, Krefeld (DE); Thomas Munzmay, Dormagen (DE); Ralf Werner, Dessau (DE)

Correspondence Address: BAYER MATERIAL SCIENCE LLC, 100 BAYER ROAD, PITTSBURGH, PA, 15205, US

(21) Appl. No.: 11/122,890

(22) Filed: May 5, 2005

(30) Foreign Application Priority Data
May 11, 2004 (DE) 102004023768.9

(51) Int. Cl. C08K 3/20

(52) U.S. Cl. 524/591

(57) ABSTRACT

The present invention relates to new polyurethane and/or polyurethane-urea dispersions having ionic or potentially ionic or nonionic groups in the polymer backbone, to a process for preparing these dispersions and to their use as adhesives.

### CROSS-REFERENCE TO RELATED APPLICATION

This application claims priority under 35 U.S.C. §119 (a)-(d) to German application DE 10 2004 023 768, filed May 11, 2004.

### FIELD OF THE INVENTION

The present invention relates to new polyurethane and/or polyurethane-urea-dispersions, to a process for preparing these dispersions and to their use as adhesives.

### BACKGROUND OF THE INVENTION

The preparation of aqueous polyurethane and/or polyurethane-polyurea dispersions is known state of the art (e.g. D. Dieterich, Houben-Weyl: Methoden der Organischen Chemie, Volurne E20, pp. 1670-81 (1987)).

As described in U.S. Pat. No. 2,968,575, stable aqueous polyurethane and/or polyurethane-polyurea dispersions are prepared using, first, external emulsifiers to disperse and stabilize the polymers in water. It is found, however, that the high level of external emulsifiers needed to prepare storage-stable aqueous dispersions adversely affects the possibilities for use of such products, since these emulsifiers make the products highly hydrophilic and sensitive to water.

In this respect, polyurethane and/or polyurethane-polyurea dispersions having chemically bonded hydrophilic centres as emulsifiers clearly show an improvement. The incorporated hydrophilic centres can be cationic groups (e.g. DE-A 6 40 789), anionic groups (e.g. DE-A 14 95 745) and/or nonionic groups (e.g. DE-A 23 14 512).

Aqueous polyurethane and/or polyurethane-polyurea dispersions having the said incorporated hydrophilic centres have characteristic advantages and disadvantages. For instance, polyurethane and/or polyurethane-polyurea dispersions hydrophilicized by means of ionic groups, owing to their salt character, are virtually insensitive to high temperatures up to the boiling point. Nonionically hydrophilicized dispersions, on the other hand, coagulate when heated to temperatures above about 60° C., even. In contrast thereto, nonionically hydrophilicized dispersions are stable to freezing and electrolytes, whereas ionically hydrophilicized dispersions are not stable under these conditions.

The teaching of DE-A 26 51 506 shows one way of avoiding the disadvantages of the abovementioned hydrophilicizing groups by combining ionic and nonionic hydrophilic groups. Polyurethane-polyurea dispersions according to DE-A 26 51 506, however, have the disadvantage that they are not very suitable as adhesives.

A teaching relating to the preparation of aqueous polyurethane and/or polyurethane-polyurea dispersions suitable as adhesives, in particular by the thermal activation method, is described for example in DE-A 28 04 609, EP-A 259 679 and DE-A 37 28 140. The aqueous polyurethane-polyurea dispersions described/disclosed therein are prepared only by the acetone process. That process, however, entails the use of large amounts of organic solvents, as auxiliary solvents, which have to be removed, inconveniently, by distillation following the preparation of the polyurethane and/or polyurethane-polyurea dispersions.

DE-A 37 35 587 describes the solvent-free preparation of polyurethane and/or polyurethane-polyurea dispersions suitable as adhesives. The two-stage preparation process disclosed therein, however, proves in practice to be impossible to accomplish, or to be accomplishable only at great cost and inconvenience. It turns out, moreover, that the dispersions have activation temperatures which are too high for the thermal activation process. In the case of the thermal activation process the workpieces are coated in a first step with the adhesive. Evaporation of the solvent or water produces a tack-free adhesive film. This film is activated by heating, using an infrared lamp, for example. The temperature at which the adhesive film becomes tacky is termed the activation temperature. Generally speaking, the aim is for a very low activation temperature of 40 to 60° C., since higher activation temperatures necessitate an unfavourably high energy expense and make manual joining more difficult, if not impossible.

One way of preparing aqueous polyurethane and/or polyurethane-polyurea dispersions suitable as adhesives particularly by the thermal activation process is described/disclosed, for example, by DE-A 101 52 405. Therein, through the use of special polyesterpolyols which contain aromatic metal sulphonate groups, aqueous polyurethane and/or polyurethanepolyurea dispersions can be obtained which have good activatability at 50 to 60° C. These polyesters containing aromatic metal sulphonate groups, however, are difficult to obtain and, owing to the dicarboxylic acids containing metal sulphonate groups or sulphonic acid groups, required for use as raw materials, are very expensive.

A disadvantage of the prior-art processes is that the dispersion adhesives exhibit an inadequate initial heat resistance.

### SUMMARY OF THE INVENTION

An object of the present invention was therefore to provide new polyurethane and/or polyurethane-urea dispersion adhesives which possess a sufficiently high initial heat resistance.

Surprisingly it has now been found that the aqueous polyurethane and/or polyurethanepolyurea dispersions of the invention, below, are outstandingly suitable for use as adhesives in the thermal activation process.

The present invention provides aqueous polyurethane and/or polyurethane-polyurea dispersions which contain not only ionic or potentially ionic groups but also nonionic groups, the ionic or potentially ionic groups being introduced into the polymer backbone via a difunctional polyol component which additionally contains 0.5 to 2 mol of sulphonic acid or sulphonate groups per molecule and the nonionic groups being introduced into the polymer backbone via one or more than one compound which is monofunctional for the purposes of the isocyanate polyaddition reaction, has an ethylene oxide content of at least 50% by weight and has a molecular weight of at least 400 daltons, and the dispersion containing 0.1% to 7.5% by weight of an emulsifier not chemically attached to the polymer.

The present invention further provides a process for preparing the aqueous polyurethane and/or polyurethane-polyurea dispersions of the invention, the process comprising the steps of:
1) reacting
   A) polyols having a functionality of two or more and a molecular weight of 400 to 5000 g/mol daltons,
   B) optionally, polyol components having a functionality of two or more and a molecular weight of 62 to 399 daltons,
   C) one or more compounds which are monofunctional for the purposes of the isocyanate polyaddition reaction, have an ethylene oxide content of at least 50% by weight and have a molecular weight of at least 400 daltons, and
   D) one or more difunctional polyol components which additionally contain 0.5 to 2 mol of sulphonic acid or sulphonate groups per molecule, with
   E) one or more diisocyanate or polyisocyanate components
to give an isocyanate-functional prepolymer; and
2) subsequently adding
   F) 0.1% to 7.5% by weight of an emulsifier containing no groups that are reactive towards isocyanate groups, and
   optionally, a neutralizing agent for converting free acid groups from synthesis component D) into their ionic form;
3) dispersing the mixture obtained after step 2) with water; and
4) carrying out chain extension by adding an aqueous solution of
   G) amino-functional components having a functionality of 1 to 3.

### DETAILED DESCRIPTION OF PREFERRED EMBODIMENTS

As used herein, unless otherwise expressly specified, all numbers such as those expressing values, ranges, amounts or percentages may be read as if prefaced by the word “about”, even if the term does not expressly appear. Also, any numerical range recited herein is intended to include all sub-ranges subsumed therein. Plural encompasses singular and vice versa. Also, while use of certain components of the present invention may be described in the singular in certain places, this should not be read as limiting the invention to the singular. For example, some portions of the specification may describe use of “a” compound (c), although the invention clearly encompasses use of one or more compounds identified as (c).

The aqueous polyurethane and/or polyurethane-polyurea dispersions of the invention are distinguished by low activation temperatures in the range from 50 to 60° C., very good initial heat resistances of ≦10 mm/min, preferably ≦5 mm/min, more preferably of 0 to 2 mm/min, and high heat resistances of ≧70° C., preferred ≧90° C. ant particularity preferred ≧100° C. for 1K application, that mean without additional crosslinker added. In addition they exhibit excellent adhesion to a very wide variety of substrates such as wood, leather, textiles, different grades of polyvinyl chloride (unplasticized and plasticized PVC), to rubbers or polyethylene-vinyl acetate.

In an additional aspect, the present invention provides an aqueous polyurethane and/or polyurethane-polyurea dispersion which is the reaction product of
(I) one or more diisocyanates or polyisocyanates; and
(II) A) one or more polyols having a functionality of two or more and a molecular weight of 400 to 5000 daltons,
B) optionally, one or more polyols having a functionality of two or more and a molecular weight of 62-399 daltons,
C) one or more difunctional polyols comprising 0.5 to 2 mol of sulphonic acid or sulphonate groups per molecule and
D) one or more compounds which are monofunctional for the purposes of the isocyanate polyaddition reaction, said one or more monofunctional compounds having an ethylene oxide content of at least 50% by weight and a molecular weight of at least 400 daltons;
the dispersions further comprising 0.1% to 7.5% by weight of F) an emulsifier not chemically attached to the polymer, and having chain extension accomplished by the addition of G) amino-funtional compounds having a functionality of 1 to 3.

Suitable polyols A) having a functionality of two or more are compounds having at least two isocyanate-reactive hydrogen atoms and an average molecular weight of 400 to 5000 daltons. Examples of suitable synthesis components are polyethers, polyesters, polycarbonates, polylactones and polyamides. Preferred compounds have 2 to 4, more preferably 2 to 3, hydroxyl groups, such as are known per se, for example, for the preparation of homogeneous and cellular polyurethanes and such as are described, for example, in DE-A 28 32 253, pages 11 to 18. Mixtures of different such compounds are also suitable in accordance with the invention.

Suitable polyesterpolyols include, in particular, linear polyesterdiols or else polyesterpolyols with a low degree of branching, such as may be prepared in a known way from aliphatic, cycloaliphatic or aromatic dicarboxylic or polycarboxylic acids and/or their anhydrides, such as succinic, glutaric, adipic, pimelic, suberic, azelaic, sebacic, nonanedicarboxylic, decanedicarboxylic, terephthalic, isophthalic, o-phthalic, tetrahydrophthalic, hexahydrophthalic or trimellitic acid and also acid anhydrides, such as o-phthalic, trimellitic Qr succinic anhydride, or mixtures thereof, with polyhydric alcohols, such as, for example, ethanediol, di-, tri- and tetraethylene glycol, 1,2-propanediol, di-, tri- and tetrapropylene glycol, 1,3-propanediol, butane-1,4-diol, butane-1,3-diol, butane-2,3-diol, pentane-1,5-diol, hexane-1,6-diol, 2,2-dimethyl-1,3-propanediol, 1,4-dihydroxycyclohexane, 1,4-dimethylolcyclohexane, octane-1,8-diol, decane-1,10-diol, dodecane-1,12-diol or mixtures thereof, optionally with the additional use of polyols of higher functionality, such as trimethylolpropane, glycerol or pentaerythritol. Polyhydric alcohols for preparing the polyesterpolyols also suitably include, of course, cycloaliphatic and/or aromatic di- and polyhydroxyl compounds. In place of the free polycarboxylic acid it is also possible to use the corresponding polycarboxylic anhydrides or corresponding polycarboxylic esters of lower alcohols or mixtures thereof for preparing the polyesters.

The polyesterpolyols can of course also be homopolymers or copolymers of lactones, which are obtained preferably by addition reaction of lactones or lactone mixtures, such as butyrolactone, ε-caprolactone and/or methyl-ε-caprolactone, with the suitable starter molecules, having functionalities of two and/or more, such as, for example, the polyhydric alcohols of low molecular weight specified above as synthesis components for polyesterpolyols. The corresponding polymers of ε-caprolactone are preferred.

Hydroxyl-containing polycarbonates as well are suitable polyhydroxyl components, examples being those which can be prepared by reacting diols such as 1,4-butanediol and/or 1,6-hexanediol with diaryl carbonates, such as diphenyl carbonate, dialkyl carbonates, such as dimethyl carbonate, or phosgene.

Examples of suitable polyetherpolyols include the polyaddition products of styrene oxides, of ethylene oxide, of propylene oxide, of tetrahydrofuran, of butylene oxide, of epichlorohydrin, and also their co-addition products and grafting products, and also the polyetherpolyols obtained by condensing polyhydric alcohols or mixtures thereof and the polyetherpolyols obtained by alkoxylating polyhydric alcohols, amines and amino alcohols. Polyetherpolyols suitable as synthesis components A) are the homopolymers, copolymers and graft polymers of propylene oxide and of ethylene oxide which are obtainable by subjecting the said epoxides to addition reaction with low molecular weight diols or triols, as specified above as synthesis components for polyesterpolyols, or with low molecular weight polyols of higher functionality such as pentaerythritol, for example, or sugars, or with water.

Preferred polyols A) with a functionality of 2 or more are polyesterpolyols, polylactones and polycarbonates. Particular preference is given to largely linear polyesterpolyols comprising as synthesis components adipic acid and butane-1,4-diol and/or hexane-1,6-diol. Likewise particularly preferred are largely linear polycaprolactones. Largely linear for the purposes of this invention is taken to denote an average, arithmetic functionality, based on hydroxyl groups, of 1.9 to 2.35, preferably of 1.95 to 2.2 and more preferably of 2.

Polyol components with a functionality of 2 or more and a molecular weight of 62 to 399 daltons that are suitable as synthesis component B) are the products listed under A), provided that they have a molecular weight of 62 to 399 daltons. Examples of further suitable components include the polyhydric, especially dihydric, alcohols specified for preparing the polyesterpolyols, and also, moreover, low molecular weight polyesterdiols such as, for example, bis(hydroxyethyl) adipate or short-chain homo-addition and co-addition products of ethylene oxide or of propylene oxide that are prepared starting from aromatic diols. Examples of aromatic diols which may find use as starters for short-chain homopolymers and copolymers of ethylene oxide or of propylene oxide are, for example, 1,4-, 1,3- and 1,2-dihydroxybenzene or 2,2-bis(4-hydroxyphenyl)propane (bisphenol A).

Compounds which are monofunctional for the purposes of the isocyanate polyaddition reaction, have an ethylene oxide content of at least 50% by weight and a molecular weight of at least 400 daltons, and are suitable as synthesis components C) are hydrophilic synthesis components for incorporating terminal hydrophilic chains, containing ethylene oxide units, of the formula (I)
H—Y′-X-Y—R (I)
in which
R is a monovalent hydrocarbon radical having 1 to 12 carbon atoms, preferably an unsubstituted alkyl radical having 1 to 4 carbon atoms,
X is a polyalkylene oxide chain having 5 to 90, preferably 20 to 70, chain members, of which at least 51%, preferably at least 65%, are composed of ethylene oxide units and which in addition to ethylene oxide units may be composed of propylene oxide, butylene oxide or styrene oxide units, preference among the latter units being given to propylene oxide units, and
Y preferably is oxygen
Y′ preferably is oxygen or else is —NR′—, where R′ with respect to its definition corresponds to R or hydrogen.

It is preferred to use monofunctional synthesis components C), however, only in molar amounts of <10 mol %, based on the polyisocyanate used, in order to ensure the desired high molecular weight structure of the polyurethanes and/or polyurethane-polyureas. If larger molar amounts of monofunctional alkylene oxide polyether C) are used then it is advantageous to use, additionally, trifunctional compounds containing hydrogen atoms that are reactive towards isocyanate, albeit with the proviso that the average of the functionality of the starting compounds A) to C) is not greater than 2.7, preferably not greater than 2.35. The monofunctional hydrophilic synthesis components are prepared in analogy to the manner described in DE-A 23 14 512 or 23 14 513 or in U.S. Pat. No. 3,905,929 or 3 920 598, by alkoxylating a monofunctional starter such as methanol, ethanol, isopropanol, n-butanol or N-methylbutylamine, for example, using ethylene oxide and, optionally, a further alkylene oxide such as propylene oxide.

Preferred synthesis components C) are the copolymers of ethylene oxide with propylene oxide, with an ethylene oxide mass fraction of greater than 50%, more preferably of 55% to 89%.

In one preferred embodiment synthesis components C) used are compounds having a molecular weight of at least 400 daltons, preferably of at least 500 daltons and more preferably of 1200 to 4500 daltons.

Suitable synthesis components D) are diols which additionally contain 0.5 to 2 mol, preferably 0.8 to 1 mol, of sulphonic acid or sulphonate groups per molecule. Suitable synthesis components D) are compounds corresponding to the general formula (II) 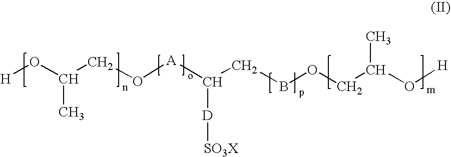
where
A and B are equivalent or different, divalent, aliphatic hydrocarbon radicals having 1 to 12 carbon atoms,
D is an aliphatic hydrocarbon radical having 0 to 6 carbon atoms,
X is an alkali metal cation, a proton or NR₄⁺, where R₄ represents identical or different radicals, with R=hydrogen or an aliphatic or cycloaliphatic radical having 1 to 6 carbon atoms,
n and m are identical or different natural numbers, with n+m being a number from 0 to 30, and
o and p are each 0 or 1.

Where synthesis components D) are used in the form of free sulphonic acids they must be converted into their ionic form by adding suitable neutralizing agents before the polymer melt is transferred into water. Suitable neutralizing agents are, for example, tertiary amines such as triethylamine, tripropylamine, diisopropylethylamine, dimethylethanolamine or triethanolamine, inorganic bases, such as ammonia or sodium hydroxide or potassium hydroxide, hydrogen carbonate or carbonate. A preferred counterion is the sodium ion.

Preferred synthesis components D) are those having a number-average molecular weight of 200 to 4000 daltons, preferably of 300 to 2000 daltons. Especially preferred synthesis components D) are those obtainable by addition reaction of alkali metal hydrogen sulphite with propoxylated 2-butene-1,4-diol having a degree of propoxylation of n+m=4 to 8.

Suitable synthesis components E) are any desired organic compounds which contain at least two free isocyanate groups per molecule. It is preferred to use diisocyanates Y(NCO)₂, where Y is a divalent aliphatic hydrocarbon radical having 4 to 12 carbon atoms, a divalent cycloaliphatic hydrocarbon radical having 6 to 15 carbon atoms, a divalent aromatic hydrocarbon radical having 6 to 15 carbon atoms or a divalent araliphatic hydrocarbon having 7 to 15 carbon atoms.

Examples of such diisocyanates whose use is preferred are tetramethylene diisocyanate, methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 2,2-bis(4-isocyanatocyclohexyl)propane, 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate, p-isopropylidene diisocyanate, and mixtures of these compounds.

Further examples of compounds which can be used as the diisocyanate component are described for example by W. Siefken in Justus Liebigs Annalen der Chemie, 562, pp. 75-136.

It is of course also possible to make additional, proportional, use of the polyisocyanates of higher functionality that are known per se in polyurethane chemistry, or else of modified polyisocyanates that are known per se, such as polyisocyanates containing carbodiimide groups, allophanate groups, isocyanurate groups, urethane groups and/or biuret groups, for example.

Also suitable besides these simple diisocyanates are polyisocyanates which contain heteroatoms in the radical linking the isocyanate groups and/or possess a functionality of more than 2 isocyanate groups per molecule. The former are polyisocyanates synthesized from at least 2 diisocyanates, being prepared for example by modification of simple aliphatic, cycloaliphatic, araliphatic and/or aromatic diisocyanates, and having a uretdione, isocyanurate, urethane, allophanate, biuret, carbodiimide, iminooxadiazinedione and/or oxadiazinetrione structure. As an example of an unmodified polyisocyanate having more than 2 isocyanate groups per molecule mention may be made, for example, of 4-isocyanatomethyloctane 1,8-diisocyanate (nonane triisocyanate).

Particularly preferred diisocyanates E) are aliphatic and araliphatic diisocyanates such as hexamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 2,2-bis(4-isocyanatocyclohexyl)propane, and mixtures of these compounds.

Suitable components F) include known surfactants and emulsifiers as described for example by K. Kosswig in K. Kosswig & H. Stache—“Die Tenside”, Carl Hanser Verlag 1993, page 115-177. Preference is given to nonionic surfactants (pp. 147-161). Suitable nonionic external emulsifiers include reaction products of aliphatic, araliphatic, cycloaliphatic or aromatic carboxylic acids, alcohols, phenol derivatives and/or amines with epoxides, such as ethylene oxide, for example. Examples thereof are reaction products of ethylene oxide with carboxylic acids of castor oil, of abietic acid, of lauric, myristic, palmitic, margaric, stearic, arachidic, behenic and/or lignoseric acid or unsaturated monocarboxylic acids such as oleic, linoleic, linolenic and/or ricinoleic acid or aromatic monocarboxylic acids such as benzoic acid, with fatty acid alkanol amides, with relatively long-chain alcohols such as oleyl alcohol, lauryl alcohol, stearyl alcohol, with phenyl derivatives such as substituted benzyl-, phenylphenols, nonyl phenols, fatty acid, and with relatively long-chain amines such as dodecylamine and stearyl amine, with fatty acid glycerides or with sorbitan esters, for example. The reaction products of ethylene oxide are oligoethers and/or polyethers having degrees of polymerization of between 2 and 100, preferably between 5 and 50. In order to suppress the foaming behaviour it is also possible for some of the ethylene oxide to be replaced by propylene oxide. In this context it has proven to be advantageous, for minimizing the formation of foam, to add on ethylene oxide and propylene oxide in blocks. The ethoxylation products of sorbitan esters of lauric, myristic, palmitic, margaric, stearic, arachidic, behenic, lignoceric acid or unsaturated monocarboxylic acids such as oleic, linoleic, ricinoleic acid or aromatic monocarboxylic acids such as benzoic acid are particularly preferred.

Emulsifiers which have proved to be particularly advantageous for the purposes of this invention are external emulsifiers which are liquid at room temperature and have an LHB (lipophilic/hydrophilic balance) of 12 to 18, preferably of 15 to 18. Examples are Emulsifier EA 9 (lauryl alcohol, mol EO 30), EA 12 (stearyl alcohol, mol EO 7), EA 17 (oleyl alcohol, mol EO 19), EPS 4 (phenol/methylstyrene, mol EO 96.5), EPS 5 (phenol/methylstyrene, mol EO 27), EPS 8 (phenol/styrene, mol EO 29), EPS 9 (phenol/styrene, mol EO 54) (Bayer AG, Leverkusen/D), Lutensol® XL 1400 (decanol ethoxylate with about 14 mol of EO) or AP 20 (alkylphenol+20 EO) (BASF AG, Ludwigshafen/D). Particular preference is given to ethoxylation products of the fatty acid esters of sorbitol such as, for example, Tween® 20, 40, 60 or 80 (Uniqema, Wesel/D) or Merpoxen® SML 200, SMS 200 or SMO 200 (polyoxyethylene-20 sorbitan monolaurate) (Wall Chemie GmbH; Kempen/D).

The external emulsifiers are used in amounts of 0.1% to 7.5%, preferably 0.5% to 5% and more preferably 0.5% to 3% by weight, based on the non-volatile fraction of the polyurethane and/or polyurethane-polyurea dispersion.

Suitable synthesis components G) include aliphatic and/or alicyclic primary and/or secondary monoamines and polyamines, such as ethylamine, the isomeric propylamines and butylamines, higher linear-aliphatic and cycloaliphatic monoamines such as cyclohexylamine, for example, and also ethanolamine, 2-propanolamine, diethanolamine, diisopropanolamine and polyamines such as 1,2-ethanediamine, 1,6-hexamethylenediamine, 1-amino-3,3,5-trimethyl-5-aminomethylcyclohexane (isophorone diamine), piperazine, 4-diaminocyclohexane, bis(4-aminocyclohexyl)methane, adipic dihydrazide or diethylenetriamine.

Further polyamines include polyetherpolyamines which come about formally by replacement of the hydroxyl groups of the polyetherpolyols described earlier on above by amino groups. Such polyetherpolyamines can be prepared by reacting the corresponding polyetherpolyols with ammonia and/or primary amines.

A preferred synthesis component G) is hydrazine or hydrazine hydrate.

It is particularly preferred also to use the synthesis components G) in the form of mixtures of monoamines and diamines, such as ethanolamine/ethylenediamine, diethanolamine/ethylenediamine, ethanolamine/1-amino-3,3,5-trimethyl-5-aminomethylcyclohexane or diethanolamine/1-amino-3,3,5-trimethyl-5-aminomethylcyclohexane, for example. Preference is given to monoamine to diamine mixing ratios of 1:20 to 1:1, more preferably 1:15 to 1:5.

The polyurethane resin dispersions of the invention are prepared by known prior-art processes, such as, for example, D. Dieterich in Houben-Weyl “Methoden der Organischen Chemie”, Volume E20, pp. 1670-81 (1987). The polyurethane dispersions of the invention are preferably prepared by the prepolymer mixing process, as it is known.

In the prepolymer mixing process the synthesis of the aqueous preparations of polyurethane resins on which the dispersions of the invention are based takes place in a multi-stage operation.

In a first stage a prepolymer containing isocyanate groups is synthesized from the synthesis components A) to E). The amounts in which the individual components are used are such as to result in an isocyanate index of 1.1 to 3.5, preferably of 1.35 to 2.5. The isocyanate content of the prepolymers is between 1.5% and 7.5%, preferably between 2% and 4.5% and more preferably between 2.5% and 4.0%. Furthermore, when apportioning the synthesis components A) to E), it should be ensured that the arithmetic, number-average functionality is situated between 1.80 and 3.50, preferably between 1.95 and 2.25.

50 to 90 parts by weight, preferably 65 to 80 parts by weight of component A), 0 to 15 parts by weight, preferably 0 to 5 parts by weight of component B), 0.5 to 10 parts by weight, preferably 1 to 5 parts by weight of component C), 1 to 15 parts by weight, preferably 3 to 10 parts by weight of component D) and 5 to 30 parts by weight, preferably 10 to 25 parts by weight of component E) are used, with the proviso that the sum of the components makes 100.

In order to accelerate the urethanization reaction it is possible to use customary catalysts such as are known to the skilled worker for accelerating the NCO—OH reaction. Examples are tertiary amines such as triethylamine, diazabicyclooctane (DABCO) or organotin compounds such as dibutyltin oxide, dimethyltin dichloride, dibutyltin dilaurate or tin bis(2-ethylhexanoate), for example, or other organometallic compounds.

In a second stage the isocyanate-containing prepolymer prepared in the first stage is mixed and homogenized with the emulsifier F). Free sulphonic acid groups are, where appropriate, converted into their salt form by adding neutralizing agent. It has proven to be particularly advantageous to add the neutralizing agents as solutions in synthesis component F).

In a third stage the isocyanate-containing and emulsifier-containing prepolymer is dispersed by addition of or by introduction into water under suitable stirring conditions. Preferably the prepolymer melt is introduced into water. The resultant isocyanate-containing dispersions have a solids content of 30% to 70% by weight, preferably of 38% to 58% by weight.

In a fourth stage the aqueous, isocyanate-containing dispersion is reacted with an aqueous solution of the amino-functional synthesis components G) to give the polyurethane and/or polyurethane-polyurea. Based on total polymer, 0.5% to 10%, preferably 1% to 7.5%, by weight of synthesis component G) is used. The concentration of the aqueous chain extender solution is 5% to 50%, preferably 8% to 35%, more preferably 10% to 25%, by weight. The amounts of the synthesis components are such as to result in 0.3 to 0.93 mol, preferably 0.5 to 0.85 mol, of primary and/or secondary amino groups in the synthesis components G) per mole of isocyanate groups in the dispersed prepolymer. The arithmetic, number-average isocyanate functionality of the resultant polyurethane-polyurea resin of the invention is between 1.5 and 3.5, preferably between 1.7 and 2.5. The arithmetic, number-average molecular weight (Mn) is between 3000 and 100 000, preferably between 4500 and 25 000 daltons.

In a fifth stage the remaining isocyanate groups are consumed by reaction of water, accompanied by chain extension. The arithmetic, number-average hydroxyl functionality of the resultant polyurethane-polyurea resin of the invention is between 1.5 and 5, preferably between 1.95 and 2.5. The arithmetic, number-average molecular weight (Mn) is between 10 000 and 425 000, preferably between 25 000 and 250 000 daltons.

Likewise provided by the present invention are adhesives comprising the polyurethane and/or polyurethaneurea dispersions of the invention.

In this context it is possible to add to the dispersions of the invention, prior to the application, polyisocyanate compounds having at least two isocyanate groups per molecule (2-component processing). Particular preference is given in this case to using polyisocyanate compounds which are emulsifiable in water. These are, for example, the compounds described in EP-A 206 059, DE-A 31 12 117 or DE-A 10024624. The polyisocyanate compounds are used in an amount of 0.1% to 20%, preferably 0.5% to 10% and more preferably 1.5% to 6% by weight, based on the aqueous preparation.

The adhesives suitable for bonding any desired substrates such as, for example, paper, board, wood, textiles, metal, leather or mineral materials. The adhesives of the invention are particularly suitable for bonding rubber materials such as natural and synthetic rubbers, for example, various plastics such as polyurethanes, polyvinyl acetate, polyvinyl chloride, including in particular—and preferably—plasticized polyvinyl chloride. Particular preference is given to their use for bonding soles of these materials, based in particular on polyvinyl chloride, especially plasticized polyvinyl chloride, or on polyethylene-vinyl acetate or polyurethane elastomer foam, to footwear uppers made of real or synthetic leather. In addition the adhesives of the invention are particularly suitable for bonding films based on polyvinyl chloride or plasticized polyvinyl chloride to wood.

The adhesives of the invention are processed by the known methods of adhesive technology as they relate to the processing of aqueous dispersion adhesives.

The following examples are intended to illustrate the invention, and should not be construed as limiting the invention in any way.

### EXAMPLES

Ingredients:

| | |
|---|---|
| Polyester I: | 1,4-Butanediol polyadipate diol of OH—N = 50 |
| Polyester II: | Polyesterdiol from 1,6-hexanediol, neopentyl glycol and Adipic acid, of |
| | OH-Z = 66 |
| Polyether I: | Polypropylene glycol of OH—N = 56 (Desmophen ® 3600, Bayer AG, |
| | Leverkusen/D) |
| Polyether II: | Ethylene oxide-propylene oxide copolymer, prepared starting from |
| | n-butanol and having an ethylene oxide content of 78% and an OH—N = 25 |
| Polyether III: | Polypropylene glycol prepared starting from butane-1,4-diol and |
| | containing a lateral sodium sulfonate group, of OH—N = 260 |
| Desmodur ® H: | Hexamethylene 1,6-diisocyanate (Bayer AG, Leverkusen/D) |
| Desmodur ® I: | Isophorone diisocyanate (Bayer AG, Leverkusen/D) |
| Desmodur ® DA: | Hydrophilic, aliphatic polyisocyanate based on hexamethylene |
| | diisocyanate |
| Emulsifier: | Tween ® 20: Polyethylene oxide ether prepared starting from sorbitan |
| | (Uniqema, Emmerich/D) |

### Example 1

### Inventive

675 g of polyester 1,64.5 g of polyether III and 20.3 g of polyether II are dewatered at 110° C. and 15 mbar for 1 hour. At 70° C. 45.4 g of Desmodur® H and then 119.9 g of Desmodur® I are added. The mixture is stirred at 80 to 90° C. until a constant isocyanate content of 3.18% is reached. Following the addition of 18.5 g of Tween® 20 the mixture is introduced with vigorous stirring into 840 g of water at 40° C. The resulting dispersion is subsequently stirred for 15 minutes and then chain extension is carried out by addition of a mixture of 12.6 g of ethylenediamine and 1.2 g of diethanolamine in 100 g of water.

This gives a solvent-free, aqueous polyurethane-polyurea dispersion having a solids content of 49.6% by weight, whose disperse phase has an average particle size, determined by laser correlation, of 210 nm.

### Example 2

### Inventive

607.5 g of polyester 1,102.0 g of polyester II, 51.6 g of polyether III and 20.3 g of polyether II are dewatered at 110° C. and 15 mbar for 1 hour. At 70° C. 45.6 g of Desmodur® H and then 121.1 g of Desmodur® I are added. The mixture is stirred at 80 to 90° C. until a constant isocyanate content of 3.16% is reached. Following the addition of 19.0 g of Tween® 20 the mixture is introduced with vigorous stirring into 855 g of water at 40° C. The resulting dispersion is subsequently stirred for 15 minutes and then chain extension is carried out by addition of a mixture of 12.6 g of ethylenediamine and 1.9 g of diethanolamine in 105 g of water.

This gives a solvent-free, aqueous polyurethane-polyurea dispersion having a solids content of 50.0% by weight, whose disperse phase has an average particle size, determined by laser correlation, of 228 nm.

### Example 3

### Inventive

540.0 g of polyester 1,120.0 g of polyether 1,65.1 g of polyether III and 20.3 g of polyether II are dewatered at 110° C. and 15 mbar for 1 hour. At 70° C. 45.4 g of Desmodur® H and then 119.9 g of Desmodur® I are added. The mixture is stirred at 80 to 90° C. until a constant isocyanate content of 3.19% is reached. Following the addition of 18.2 g of Tween® 20 the mixture is introduced with vigorous stirring into 820 g of water at 40° C. The resulting dispersion is subsequently stirred for 15 minutes and then chain extension is carried out by addition of a mixture of 12.5 g of ethylenediamine and 2.0 g of diethanolamine in 105 g of water.

This gives a solvent-free, aqueous polyurethane-polyurea dispersion having a solids content of 49.3% by weight, whose disperse phase has an average particle size, determined by laser correlation, of 145 nm.

### Example 4

### Comparison According to EP 304 718 (Example 1)

360 g of polyester I are dewatered at 110° C. and 15 mbar for 1 hour. At 80° C. 23.4 g of Desmodur® H and then 15.3 g of Desmodur® I are added. The mixture is stirred at 80 to 90° C. until a constant isocyanate content of 0.95% is reached. The reaction mixture is dissolved in 800 g of acetone and cooled to 50° C. at the same time. To the homogeneous solution is added a solution of 5.8 of the sodium salt of N-(2-aminoethyl)-2-aminoethanesulphonic acid and 2.1 g of diethanolamine in 55 g of water, with vigorous stirring. After 7 minutes the product is dispersed by adding 565 g of water. Removal of the acetone by distillation gives a solvent-free, aqueous polyurethane-polyurea dispersion having a solids content of 40.1% by weight, with a disperse phase whose average particle size, determined by laser correlation, is 115 nm.

### Application Example

A) Determination of Initial Heat Resistance

Test Material/Test Specimens

a) Renolit film (32052096 Strukton; Rhenolit A G, Worms/D)
   Dimensions: 50×300×0.4 mm
b) Beechwood sheet (planed)
   Dimensions: 50×140×4.0 mm
      Adhesive Bonding and Measurement

The adhesive dispersion is applied to the wood test specimen using a 200 μm coating blade. The bond area is 50×110 mm. The evaporation time for the applied adhesive is at least 3 hours at room temperature. Subsequently the two test specimens are placed on top of one another and joined at 77° C. under a pressure of 4 bar for 10 s. Immediately thereafter the test specimen is conditioned at 80° C., without a weight, for 3 minutes, and then loaded with 2.5 kg at 80° C. for 5 minutes, the load acting perpendicular to the bonded joint (180° peel). A measurement is made of the distance over which the bond has parted, in millimetres. The initial heat resistance is reported in mm/min.

B) Determination of Heat Resistance

1—component bonding: adhesive without crosslinker
2—component bonding: adhesive with an emulsifiable crosslinker isocyanate
3 parts of Desmodur® DA per 100 parts of adhesive are homogenized intensively.
Recommended initial amount: 25 g of adhesive and 0.75 g of crosslinker
   Test Material/Test Specimens
a) Unplasticized PVC laminating film (Benelit film, Benecke-Kaliko A G, Hannover/D)
   Dimensions: 50×210×0.4 mm
b) Beechwood sheet (planed)
   Dimensions: 50×140×4.0 mm
      Adhesive Bonding and Measurement

The adhesive dispersion (1-component) or the mixture of adhesive dispersion and crosslinker isocyanate (2-component) is applied by brush to the beechwood test specimen. The bond area is 50×110 mm. After a drying time of 30 minutes at room temperature a second layer of adhesive is applied over the first and then dried at room temperature for 60 minutes. Subsequently the two test specimens are placed one on top of the other and joined at 90° C. under a pressure of 4 bar for 10 s.

After the test specimens have been stored at room temperature for three days they are loaded with 0.5 kg at an angle of 180° to the bond joint. The initial temperature is 50° C., and after 60 minutes the temperature is raised by 10° C. per hour up to a maximum of 120° C. A measurement is made in each case of the temperature at which an adhesive bond separates completely.

TABLE 1

| | Example 1 | Example 2 | Example 4 |
|---|---|---|---|
| | inventive | | comparative |
| Initial heat resistance [mm/min] | 0.4/0.4 | 0.9/0.9 | 14/15 |
| Heat resistance, | 110 | 110 | 65 |
| 1-component [° C.] | | | |
| Heat resistance, | >120 | >120 | >120 |
| 2-component [° C.] | | | |

It will be appreciated by those skilled in the art that changes could be made to the embodiments described above without departing from the broad inventive concept thereof. It is understood, therefore, that this invention is not limited to the particular embodiments disclosed, but it is intended to cover modifications which are within the spirit and scope of the invention, as defined by the appended claims.

1. Aqueous polyurethane and/or polyurethane-polyurea dispersions comprising ionic or potentially ionic groups and nonionic groups, the ionic groups being introduced into the polymer backbone via a difunctional polyol component comprising 0.5 to 2 mol of sulphonic acid or sulphonate groups per molecule and the nonionic groups being introduced into the polymer backbone via one or more than one compound which is monofunctional for the purposes of the isocyanate polyaddition reaction, said monofunctional compound having an ethylene oxide content of at least 50% by weight and a molecular weight of at least 400 daltons, and the dispersion containing 0.1% to 7.5% by weight of an emulsifier not chemically attached to the polymer.

2. A process for preparing the aqueous polyurethane and/or polyurethane-polyurea dispersions according to claim 1, the process comprising the steps of:
1) reacting
A) polyols having a functionality of two or more and a molecular weight of 400 to 5000 daltons,
B) optionally, polyol components having a functionality of two or more and a molecular weight of 62 to 399 daltons,
C) one or more compounds which are monofunctional for the purposes of the isocyanate polyaddition reaction, have an ethylene oxide content of at least 50% by weight and have a molecular weight of at least 400 daltons, and
D) one or more difunctional polyol components which additionally contain 0.5 to 2 mol of sulphonic acid or sulphonate groups per molecule, with
E) one or more diisocyanate or polyisocyanate components
to give an isocyanate-functional prepolymer; and
2) subsequently adding
F) 0.1% to 7.5% by weight of an emulsifier containing no groups that are reactive towards isocyanate groups, and
optionally, a neutralizing agent for converting free acid groups from synthesis component D) into their ionic form;
3) dispersing the mixture obtained after step 2) with water; and
4) carrying out chain extension by adding an aqueous solution of
G) amino-functional components having a functionality of 1 to 3.

3. An adhesive composition comprising the polyurethane and/or polyurethane-urea dispersions of claim 1.

4. Rubber or plastics materials adhesively bonded with the polyurethane and/or polyurethane-urea dispersions of claim 1.

5. The rubber or plastics materials of claim 4, wherein the plastics materials are selected from the group consisting of polyurethanes, polyvinyl acetates and polyvinyl chlorides.

6. The rubber or plastics materials of claim 4, wherein the rubber or plastics materials are soles and are adhesively bonded to footwear uppers made of real or synthetic leather.

7. Films based on polyvinyl chloride or plasticized polyvinyl chloride adhesively bonded to wood with the polyurethane and/or polyurethane-urea dispersions of claim 1.

8. An aqueous polyurethane and/or polyurethane-polyurea dispersion which is the reaction product of
(I) one or more diisocyanates or polyisocyanates; and
(II) A) one or more polyols having a functionality of two or more and a molecular weight of 400 to 5000 g/mol daltons,
B) optionally, one or more polyols having a functionality of two or more and a molecular weight of 62-399 daltons,
C) one or more difunctional polyols comprising 0.5 to 2 mol of sulphonic acid or sulphonate groups per molecule and
D) one or more compounds which are monofunctional for the purposes of the isocyanate polyaddition reaction, said one or more monofunctional compounds having an ethylene oxide content of at least 50% by weight and a molecular weight of at least 400 daltons;
the dispersion further comprising 0.1% to 7.5% by weight of an F) emulsifier not chemically attached to the polymer, and having chain extension accomplished by the addition of G) amino-funtional compounds having a functionality of 1 to 3.
